(19) United States
(12) Patent Application Publication
(10) Pub. No.: US 2012/0041853 A1
(43) Pub. Date: Feb. 16, 2012

(54) FACILITATION OF A NETWORK COMMUNICATION SERVICE FOR WHICH PAYMENT MAY BE MADE BY ANY OF A PLURALITY OF PAYMENT MODES

(76) Inventors: Hemlata S. Kadia, Voorhees, NJ (US); Lior Auslander, Voorhees, NJ (US); Geoffrey Benger Coleman, Voorhees, NJ (US); Christopher Allen Doehler, Lone Tree, CO (US); Bruce Frankel, Marlton, NJ (US); Gabriel Matsliach, Voorhees, NJ (US); David M. Sell, Howell, NJ (US); Pankaj Trivedi, Voorhees, NJ (US)

(21) Appl. No.: 13/266,107

(22) PCT Filed: Apr. 30, 2009
(86) PCT No.: PCT/US09/42435

§ 371 Date: Oct. 24, 2011

(51) Int. Cl. G06Q 30/00

(52) U.S. Cl. 705/30

(57) ABSTRACT

There is provided a method that includes (i) receiving a notification of an event concerning a network communication service, (ii) querying a database, in response to the notification, to obtain a payment mode for the service, in which the payment mode is selectable from a set that includes (a) pre-payment and (b) post-payment, (iii) determining, in accordance with the payment mode, whether a balance to fund the service satisfies a balance criterion, and (iv) issuing, in accordance with whether the balance to fund the service satisfies the balance criterion, a communication to a device to affect a provision of the service. There is also provided a system that employs the method, and a storage medium that contains instructions for controlling a processor to perform the method.

### BACKGROUND OF THE INVENTION

1. Field of the Invention

The present invention relates to a communication system, and more specifically, a telecommunication system in which payment for a network communication service may be made by any of a plurality of payment modes.

2. Description of the Related Art

Consumers of telecommunications services generally fall into two categories. One category is prepaid subscribers, who pay in advance for credit that is then consumed as services are used. The other category is postpaid subscribers, in which the account-holder (subscriber) receives an invoice detailing charges for services used, and the account-holder pays the total due in arrears.

In conventional billing systems, if a subscriber wishes to change their payment mode from prepaid to postpaid (or vice-versa), a complex workflow must be executed to cease the subscriber's services in a prepaid system and re-provide or initiate those same services in a postpaid system. Even when a single billing/customer care system is used for both prepaid and postpaid subscribers, a subscriber must nonetheless be defined as either prepaid or postpaid.

It would be desirable to have a subscriber system for telecommunication services. It would be further desirable to have a subscriber system in which the subscriber has the option of paying in either or both of prepaid and postpaid modes without being categorized and/or limited to one mode or the other.

### SUMMARY OF THE INVENTION

There is provided a method that includes (i) receiving a notification of an event concerning a network communication service, (ii) querying a database, in response to the notification, to obtain a payment mode for the service, in which the payment mode is selectable from a set that includes (a) pre-payment and (b) post-payment, (iii) determining, in accordance with the payment mode, whether a balance to fund the service satisfies a balance criterion, and (iv) issuing, in accordance with whether the balance to fund the service satisfies the balance criterion, a communication to a device to affect a provision of the service. There is also provided a system that employs the method, and a storage medium that contains instructions for controlling a processor to perform the method.

### DESCRIPTION OF THE FIGURES

FIG. 1 is a block diagram of an embodiment of a hybrid subscriber system of the present invention.

FIG. 2A is a block diagram of another embodiment of a hybrid subscriber system of the present invention.

FIG. 2B is a continuation of the block diagram of FIG. 2A.

FIG. 3 is a block diagram of a system that facilitates a network communication service for which payment may be made by any of a plurality of payment modes.

### DETAILED DESCRIPTION OF THE DISCLOSURE

The following are abbreviations used herein:

“API” stands for Application Programming Interface;
“CSR” stands for Customer Service Representative;
“CSP” stands for Communication Service Provider;
“GUI” stands for Graphical User Interface;
“MVNO” stands for Mobile Virtual Network Operator;
“NRC” stands for Non-Recurring Charge;
“RC” stands for Recurring Charge; and
“URE” stands for Unified Rating Engine.

The following are general descriptions of terms used herein.

An “Account” is an entity that represents a customer of an operator. An account can be billable (for example, a liable party that owns accounts-receivable) or non-billable. An account can have subscriber profile details and can have associated subscribers and offers. An account can have one or more child accounts (organized in a hierarchy), as well as one or more subscribers and offers. An account can have real-time balances and accumulators.

An “accumulator” is a register for counting or measuring transactional activity including calls, recharges, data sessions, and SMS. Accumulators are cyclical in nature in that they are periodically reset back to zero. The reset period is configurable with supported periods of daily, weekly, monthly, quarterly, yearly, bill cycle, or none. System-initiated activities like recurring charges are not accumulated. A single accumulator is provisioned to count one type of chargeable activity (for example, voice call seconds or SMS message count). Accumulators can count a quantity (for example, number of calls) or volume (for example, total amount of recharges). Accumulators are often used for triggering real-time promotions.

An “Award” is a rule that applies a monetary amount or non-monetary units to a balance. Sources for awards include voucher purchases, recharges, RCs, and bonus plans. The award can be consumed in real time through usage that occurs after the award has been granted.

A “Balance” is a collection of funds of a similar unit type. Balances can be either (1) running (real-time authorization) balances or (2) financial (accounts-receivable) balances. A balance is a representation of either a monetary or a nonmonetary (units-based) amount. A balance can be either postpaid or prepaid. A postpaid balance can signify a unit amount, a monetary credit, a spending limit, or the total amount due, all of which are incremented based upon user consumption activity. A real-time prepaid balance can represent the reserved holding of funds or units drawn from when a user consumes services.

A “Balance Order” is the order in which usage, recurring, and non-recurring charges are applied to the balances associated with the subscriber and accounts.

A “Billing and Financials Engine” bills and generates a invoice and/or statement for usage charges, recurring charges, non-recurring charges and any other charges applied to prepaid balances, postpaid balances, or both.

A “Bonus” is a promotion scheme that rewards a subscriber with discounts or awards based upon specific subscriber characteristics or upon achieving a certain threshold level of usage.

A “Charging” is a process of modifying balances based on the calculated amounts for RC terms, NRC terms, and usage.

A “Credit Limit” is an operator-defined, cyclical balance limit used to limit exposure on a postpaid balance. On a periodic basis, the balance may be reset to this limit. If a balance reaches its minimum value (usually 0) during a cycle, then that balance may not be used to authorize events until it is reset to the limit value at the start of the next cycle. Supported cycles include, but are not limited to, daily, weekly, monthly, quarterly, yearly or annually, bill cycle, and none or no cycle.

A “Customer Care Interface” is a graphical user interface used to create and manage accounts, subscribers, and hierarchies. The Customer Care Interface manages the customer (i.e. account and subscriber) lifecycles from customer care and ordering to fulfillment, billing, and payments. The interface is accessible to the one or more subscribers. The interface can receive acceptances of the one or more offers from the one or more subscribers and receive instructions concerning whether the payment mode for one or more offers is to be prepaid, postpaid, or both The interface also can display one or more usage, recurring, and non-recurring charges corresponding to the one or more offers as being are prepaid or postpaid.

An “Invoice” is a cyclically generated or on-demand detailed listing of charges, taxes, and outstanding balance against an account, associated discounts or credits, and adjustments. An invoice also may include an invoice number, an invoice date, or a total amount. An invoice can be generated and formatted for dispatch to customers.

An “Offer” is a minimum-sellable entity that can be delivered to an account or subscriber for the consumption of service. An offer may be a collection of reusable building blocks that models its activity usage type, service, price, eligibility, and dependencies with other offers, correlated resources, service payments, and consumed credits. Common types of offers are a primary offer, a supplementary offer, and an account offer. A primary offer can be purchased by one or more subscribers. Each subscriber has only one primary offer. The primary offer is a mandatory offer. The primary offer preferably consists of basic offers that a CSP has put in market. A supplementary offer can also be purchased by one or more subscribers. A subscriber can have one or more supplementary offers. A supplementary offer is not mandatory. A supplementary offer is used for offering value-added services. An account offer can be purchased or associated to accounts (not to subscribers). An account offer is also optional. These offers are used for offering promotions to accounts, such as a family account or a corporate account.

A “Payment” is the transfer of money from one party (such as a person or company) to another. A payment may be usually made in exchange for the provision of goods, services or both. An example is the transfer of money from a subscriber to a communication service provider in exchange for the services and goods offered.

A “Payment Mode” refers to the mode in which payment is made by a subscriber to a communications service provider. Payment can be made in a prepaid mode or a postpaid mode.

A “Postpaid Balance” is a unit amount, a monetary credit, a spending limit, or a total amount due, all of which are incremented based upon user consumption activity.

A “Postpaid Payment Mode” refers to services paid for after use, i.e., use and then pay.

A “Prepaid Balance” represents the reserved holding of funds or units drawn from when a user consumes services.

A “Prepaid Payment Mode” refers to services paid for in advance, i.e., pay and then use.

A “Product Catalog” is a system-provisioning data store for coherent and centralized management of market offerings. The Product Catalog supports multiple virtual operator product definitions within a deployment and provides various paradigms for market segmentation and product pricing. The product catalog is a single interface for design and creation of all of a CSP's offers. The product catalog supports and allows the mix of all payment types (i.e. prepaid, postpaid, and hybrid) for lines of business and for subscribers.

The term “Real Time” describes an activity or transaction that occurs during the rating and/or charging process, as opposed to waiting until the end of a cycle (bill time). A “real-time” rating and/or charging process takes place, in most cases, during the actual duration of the usage event that is being rated and/or charged.

A “Recurring/Non-Recurring Charge Server” is an entity that generates recurring and non-recurring charges and applies them to subscriber balances. The recurring and non-recurring charge server can apply recurring and non-recurring charges to a prepaid balance, a postpaid balance, or both corresponding to offers accepted by subscribers.

A “Self-Care Interface” takes the form of a Customer Service Representative that creates and manage accounts, subscribers, and hierarchies. The interface manages the customer (i.e. account and subscriber) lifecycles from customer care and ordering to fulfillment, billing, and payments. The interface is accessible to the one or more subscribers by telephone or computer. The interface can receive acceptances of the one or more offers from the one or more subscribers and receive instructions concerning whether the payment mode for one or more offers is to be prepaid, postpaid, or both.

A “Spending Limit” is a user-definable (account-definable) cyclical limit on a balance and is put in place to voluntarily control spending on a balance. A spending limit is used to limit exposure on a postpaid balance. Spending limits are reset cyclically and are not impacted by payments.

A “Statement” is a cyclically generated or on-demand detailed listing of user charges, taxes, remaining balance against an account, associated discounts, or credits. A statement can also include a statement number, a statement date, and a statement amount. A statement can be generated and formatted for dispatch to customers, if desired. A statement can be transmitted by any known method, such as electronically, via facsimile, via hardcopy, or viewing online through the internet or the Worldwide Web.

A “Subscriber” refers to: (a) A person who uses the product or service or (b) a specific service-delivery point for a product or service, e.g., a telephone line, a login account for an online service, and an end point in a leased line network.

A “Unified Rating Engine” enables operators to charge for all telecom services in real time and non-real time with complete real-time balance management for prepaid, postpaid, and hybrid customers. The unified rating engine can apply usage charges to a prepaid balance, a postpaid balance, or both corresponding to offers accepted by subscribers.

The Unified Rating Engine has a flexible charging model that can adapt to evolving customer models with the ability to limit overall customer liabilities for reduced financial risk. It enables real-time and deferred promotions, with cross-product discounting to create innovative marketing offers for penetrating new customer segments and reducing churn. It supports many rating features to meet a wide range of requirements from the wireline, mobile, cable, and Internet broadband industries.

In the present disclosure, a Hybrid Subscriber may use either prepaid payment mode, postpaid payment mode, or both at the same time. Both postpaid and prepaid payment modes may be used to pay for the same services, and the subscriber may change between the payment modes at any time without needing to set up a new account in one or more billing systems.

The present disclosure affords many advantages. One advantage is operational excellence and efficiency. Complex prepaid/postpaid migration workflows with their attendant risk of failure and operational cost are eliminated. Another advantage is real-time customer management and flexibility. The subscriber does not have to migrate from one payment method to the other at a single point in time. The subscriber can continue to use the existing payment method after the other payment method has been enabled. Yet another advantage is a consistent customer experience. An account-holder only needs to access a single self-care system using a single set of account/login details affording a streamlined customer experience. Still yet another advantage is a 360-degree customer view. The CSR can view a single account for a customer's prepaid and postpaid activities. Therefore, customer care activities are likely to be quicker and more accurate.

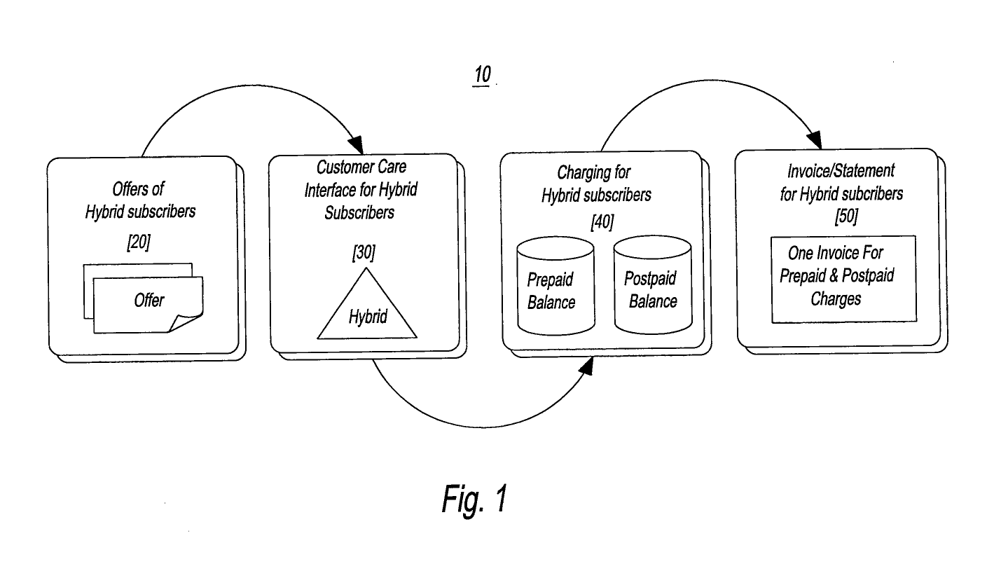

An embodiment of the system of the present disclosure is generally referenced by the numeral 10 is shown in FIG. 1. The block diagram has components designated as Offers for Hybrid Subscribers [20]; Customer Care for Hybrid Subscriber [30]; Charging for Hybrid Subscriber [40]; and Invoicing/Statement for Hybrid Subscriber [50].

### [20] Offers for Hybrid Subscribers

Through a Product Catalog interface, a single set of market offerings can be defined to operate in substantially the same way regardless of the payment mode. The defined offers can be subscribed by one or more subscribers belonging to a CSP.

If subscriber subscribes to one or more offers with different payment modes, the subscriber is classified as a hybrid subscriber rather than a prepaid subscriber (a subscriber having a prepaid payment mode for all subscribed offers) or a postpaid subscriber (a subscriber having a postpaid payment mode for all subscribed offers).

### [30] Customer Care for Hybrid Subscriber

Through the Customer Care Interface, a CSR can view hybrid subscribers' offers and their corresponding payment modes, the current state of prepaid and postpaid balances, and transaction histories and perform operations using a single user interface. Within the Customer Care Interface, the hybrid subscriber may choose a Self-Care Interface or a Customer-Care Interface.

Through the Self-Care Interface, a hybrid subscriber can view the subscriber offers, and their corresponding payment mode, the current state of prepaid and postpaid, and recent transaction history using a single user interface.

The hybrid subscriber can change the payment mode corresponding to one or more subscribed offers through the Customer Care Interface (by calling the CSR) or through the Self-Care Interface without the need to change to a different marketing offer.

### [40] Charging for Hybrid Subscriber

Usage charges for a hybrid subscriber can be applied to one or more prepaid and/or postpaid balances, in real-time mode or in off-line mode, by a Unified Rating Engine. The prepaid and postpaid balances are available to the hybrid subscriber by one or more subscribed offers. The hybrid subscriber can get promotions on prepaid offers based on postpaid offers and vice versa.

Recurring charges and non-recurring charges corresponding to the subscribed offers are applied to the hybrid subscriber's prepaid and postpaid balances by a Recurring Charge (RC) and Non-Recurring Charge (NRC) server.

Bill-time charges, adjustments, credits, debits, and bill-time promotions for hybrid subscribers can be applied to postpaid balances by a Billing and Financials engine. Bill-time promotions can also redirect awards to a hybrid subscriber's prepaid balances.

### [50] Invoicing/Statement for Hybrid Subscriber

A hybrid subscriber can receive a single document (invoice/statement) that details all transactions, both prepaid and postpaid by the Billing and Financials Engine. Thus, a convergent bill can be provided in which all telecommunication activities are detailed regardless of the lines of business (e.g. mobile, fixed, internet, and cable) and payment mode (prepaid or postpaid).

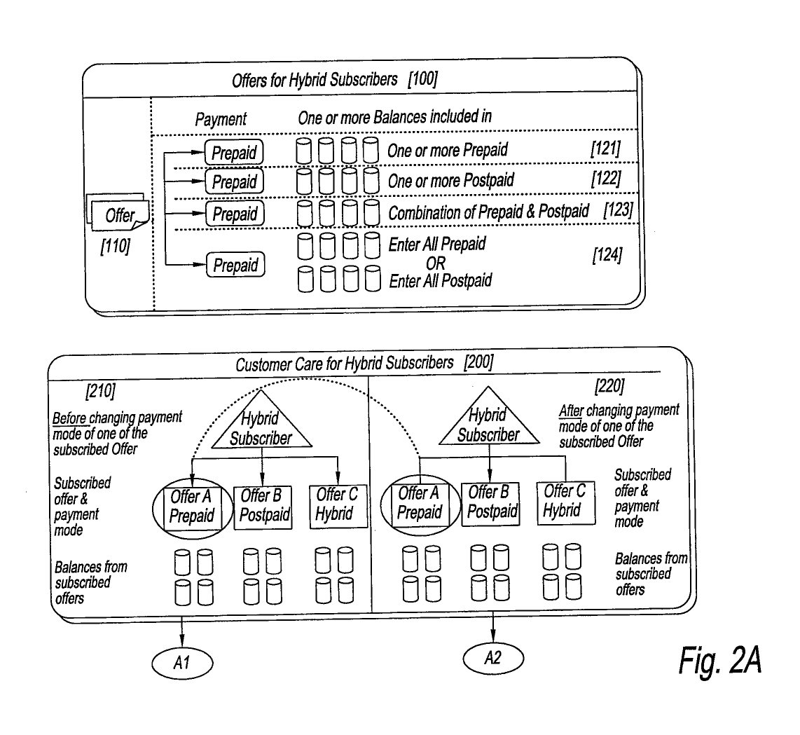

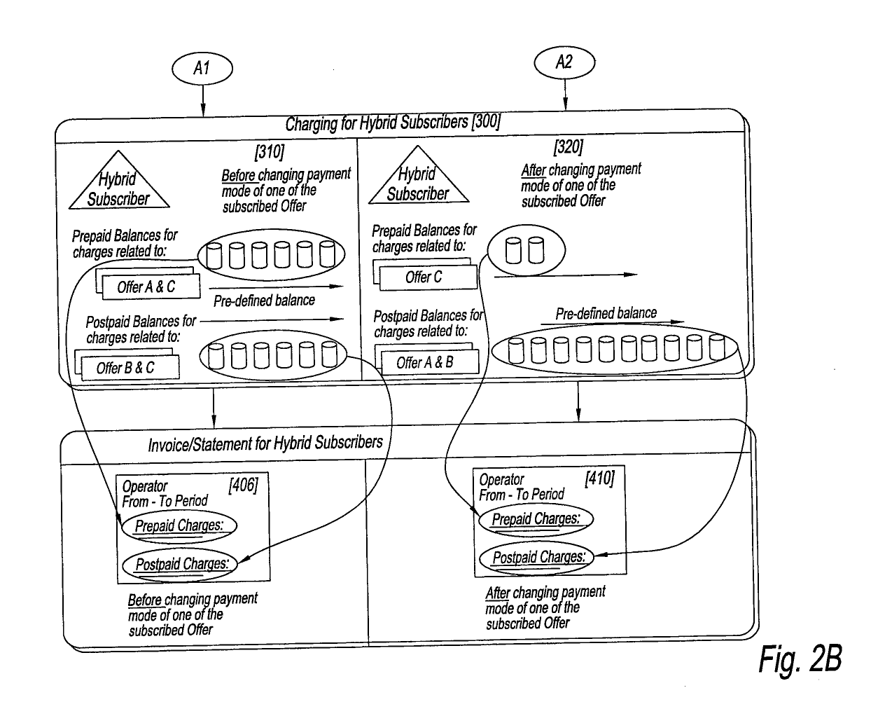

An embodiment of the present disclosure is generally referenced by the numeral 90 is shown in FIGS. 2A and 2B. The block diagram has components designated as Offer for Hybrid Subscribers [100], Customer Care for Hybrid Subscribers [200], Charging for Hybrid Subscriber [300], and Invoicing/Statement for Hybrid Subscriber [400].

### [100] Offers for Hybrid Subscribers

[100] Offers for Hybrid Subscribers illustrates marketing offers with different payment modes that can be defined by the Product Catalog Interface. The defined offers are available for subscription to one or more subscribers. A hybrid subscriber may have one or more offers with different payment modes.

[100] Offers for Hybrid Subscribers takes the form of [110] Offers, which takes the form of the following payment modes: [121] “Prepaid” payment mode and related balances, [122] “Postpaid” payment mode and related balances, [123] “Hybrid” payment mode and related balances, and [124] “Either” payment mode and related balances.

### [110] Offers

Offers are sellable entities that are available for subscription to hybrid subscribers. Services such as VoiceCall, Short Message Service (SMS), Multimedia Messaging Service (MMS), data, VoiceMail, Call Forwarding, DSL, cable, and combinations thereof are delivered to hybrid subscribers through offers. Offers can also include one or more balances. Balances are used for applying payments corresponding to the services subscribed by the hybrid subscriber.

Each offer has a payment mode that determines how the hybrid subscriber is going to pay for the services delivered by offer. The following payment modes are supported for offers. The payment mode of the offer determines the balance type as prepaid or postpaid for the balances included in the offer.

[121] “Prepaid” payment mode and related balances

A payment mode for an offer can be configured as “prepaid” in a Product Catalog. If the payment mode for an offer is configured as “prepaid, the hybrid subscriber is expected to pay for the services included in the corresponding offer in advance, i.e., pay and use.

All balances included in the corresponding offer are automatically classified as prepaid balances. Prepaid balances represent the reserved holding of funds or units that the hybrid subscriber can consume for services included in the corresponding offer.

[122] “Postpaid” payment mode and related balances

A payment mode for an offer can be configured as “postpaid” in a Product Catalog. If the payment mode for an offer is configured as “postpaid”, the hybrid subscriber is expected to pay for the services included in the corresponding offer after use, i.e., use and pay.

All balances included in the corresponding offer are automatically classified as postpaid balances. Postpaid balances represent unit amount, a monetary credit, a spending limit, or the total amount due, all of which are incremented based upon user consumption activity.

[123] “Hybrid” payment mode and related balances Payment mode for an offer can be configured as “hybrid” in a Product Catalog. If the payment mode for an offer is configured as “hybrid”, the hybrid subscriber can pay for some services in prepaid payment mode and for other services in postpaid payment mode.

The CSP/MVNO's marketing user has a choice to individually specify the balance type for each balance included in the offer as either prepaid or postpaid. This enables charging for services in prepaid mode while for other services in postpaid mode for the hybrid subscriber.

[124] “Either” payment mode and related balances

A payment mode for an offer can be configured as “either” in a Product Catalog. If the payment mode for an offer is configured as “either”, the hybrid subscriber has an option to decide whether to pay for all the services included in the offer in prepaid payment mode or postpaid payment mode. When the payment mode is “either” in the Product Catalog, the hybrid subscriber cannot choose to pay for some services included in the offer in prepaid mode while for others in postpaid mode.

If the hybrid subscriber decides to pay for all the services included in the offer in prepaid payment mode, then the balance type for all the balances included in the corresponding subscribed offer are set to prepaid. If the hybrid subscriber decides to pay for all the services included in the offer in postpaid payment mode, then the balance type for all the balances included in the corresponding subscribed offer are set to postpaid.

### [200] Customer Care for Hybrid Subscribers

[200] Customer Care for Hybrid Subscribers illustrates a hybrid subscriber with multiple offers, each with a different payment mode. Over a period of time, the hybrid subscriber changes the payment mode of one of the subscribed offers without the need to disconnect an existing subscribed offer and reconnecting the same offer with different payment mode.

Through the Customer Care interface (through the CSR) and Self-Care interface (directly), the hybrid subscriber can get all the details of each subscribed offer and the corresponding payment modes applicable at any point of time and can view recent transaction history as well as get the current state of prepaid and postpaid balances.

### [210] Hybrid Subscriber Before Changing Payment Mode of One of the Subscribed Offers

The hybrid subscriber subscribes to multiple offers through the Customer Care Interface (through the CSR) or the Self-Service Interface. As shown In FIG. 2A, the hybrid subscriber has subscribed to three offers, each with a different payment mode. Offer A is with a payment mode of prepaid, Offer B with a payment mode of postpaid, and Offer C with a payment mode of hybrid.

The balances included in the subscribed offers are available to the hybrid subscriber for charging and/or consuming for the services included in the subscribed offers. In FIG. 2B, the hybrid subscriber receives prepaid balances from Offers A and C and postpaid balances from Offers B and C.

### [220] Hybrid Subscriber Changes Payment Mode of One of the Subscribed Offers

The hybrid subscriber can change the payment mode of one or more subscribed offers at any point time, from prepaid to postpaid (and vice-versa), without the need to disconnect existing offers and reconnecting new offers with different payment modes. When a payment mode of an offer is changed, the balance type of the balances included in the corresponding offer is also automatically changed accordingly.

In FIG. 2B, the hybrid subscriber changed the payment mode of Offer A (which was originally prepaid) to postpaid. The balance type for all the balances included in the Offer A is changed to postpaid from prepaid automatically.

In conventional billing systems, if a subscriber wishes to change their payment mode from prepaid to postpaid (or vice-versa), a complex workflow must be executed to cease the subscriber's services in a prepaid system and re-provide those same services in a postpaid system. Even when a single billing/customer care system is used for both prepaid and postpaid subscribers, a subscriber must be defined as either prepaid or postpaid and migrating an account from prepaid to postpaid is a complex operation. In the hybrid billing system of the present invention, migration between postpaid and prepaid is not necessary.

The Customer Care and Self-Care interfaces are agnostic of the prepaid and postpaid payment modes. Example: A common customer care scenario is where a previous charge needs to be adjusted. This can occur when a customer was charged an incorrectly-rated amount or when the customer did not receive a service that was paid for (due to network unavailability for example). The system of the present invention addresses these situations in the same way for both prepaid and postpaid charges. The CSR does not need to know what payment method was used for a given charge. Creating an adjustment for a charge automatically credits the balances that were used to pay for the charge originally.

### [300] Charging for Hybrid Subscriber

[300] Charging for Hybrid Subscriber illustrates the step of charging to a hybrid subscriber's prepaid and postpaid balances. The set of prepaid and postpaid balances available for charging changes when the payment mode of one of the subscribed offers is changed.

In FIG. 2B for both [310] and [320], the hybrid subscriber has number of prepaid and postpaid balances that are used to pay for service usage and other charges (such as monthly rental and equipment charges) included in the subscribed offers.

The difference between [310] and [320] is the number of available prepaid balances versus postpaid balances. The hybrid subscriber changed the payment mode of one of the subscribed offers. The payment mode of Offer A was originally prepaid [in 310] but changed to postpaid [in 320]. The balance type for all balances included in the Offer A was changed to postpaid from prepaid.

In FIG. 2B for both [310] and [320], the charging to prepaid and postpaid balances remain the same as explained below. The charges are applied to the prepaid and postpaid balances by a Unified Rating Engine, a RC/NRC Server, a Recharge Server, and a Billing and Financials Engine.

Prepaid balances are incremented when the subscriber recharges (“tops up”) his account, either by buying and applying a prepaid voucher or buying credit using a credit or debit card. The prepaid balances are decremented when a service is used by the subscriber, a charge is levied, and the charge is deducted from the balance. When the balance reaches zero, no further charges may be taken from the balance (except in special circumstances such as when credit is extended) until the balance is recharged again.

Postpaid balances function in a similar way as prepaid balances in that the balance is decremented when a service is used. However, the balance is not recharged in the same way. A postpaid balance is used to limit the amount of postpaid credit available to a subscriber in a given period. Typically, the balance will be reset to a given value (for example, $50) at the beginning of each month, and when $50 has been spent (and the balance has been decremented to zero), no further charges may be taken from the balance (except in certain special circumstances such as when credit is extended) until the balance is reset at the beginning of the following month. Any charges made to a postpaid balance will be recorded in the system and invoiced to the customer.

A balance order is defined corresponding to each balance included in the offer. If a hybrid subscriber has only one offer, the defined balance order for balances in the corresponding offer is used for charging. The system also provides an option to define a priority across one or more offers. This offer priority is used when a hybrid subscriber has balances from one or more subscribed offers.

When a service is used, payment is taken from the balances in a defined order. Payment is taken from the first balance up to the balance's limit, then from the second balance up to the balance's limit, and so on until the charge has been paid for. In this way, a service may result in a charge being made to a prepaid balance, a postpaid balance, or both, depending on the balance order, current value of the balances, and the payment mode of the offer.

In [310], the prepaid balances are only available for charging the payments incurred by the offers for which payment mode is prepaid i.e. Offer A and Offer C.

The postpaid balances are only available for charging the payment incurred the offers for which payment mode is postpaid i.e. Offer B and C. The order in which the prepaid and postpaid charges are applied is based on the balance order specified in Offer A, Offer B, and Offer C as well as the offer priority across the mentioned three offers, i.e., Offer A, Offer B, and Offer C.

In [320], the postpaid balances are only available for charging the payments incurred through the offers for which payment mode is postpaid, i.e., only Offer C. The postpaid balances are only available for charging the payment incurred through the offers for which payment mode is postpaid, i.e., Offers A, B and C. The order in which the prepaid and postpaid charges are applied is based on the balance order specified in Offer A, Offer B, and Offer C as well as the offer priority across the mentioned three offers, i.e., Offer A, Offer B, and Offer C.

### [400] Invoicing/Statement for Hybrid Subscriber

[400] Invoicing/Statement for Hybrid Subscriber in FIG. 2B illustrates a single invoice/statement for hybrid subscriber for prepaid and postpaid charges.

In [405] & [410] in FIG. 2B, the hybrid subscriber receives a single document (invoice/statement) reflecting both prepaid and postpaid charges corresponding to the subscribed offers.

In the system of the present invention, each subscriber has an account which is a billable entity, and the account corresponding to a hybrid subscriber can receive a single document (invoice/statement) that details all transactions, both prepaid and postpaid. The document can include details of prepaid spending and prepaid recharges, as well as postpaid new charges and balance due. The document is a truly convergent bill in which all telecommunication activities can be detailed regardless of service type or payment method. CSPs will benefit from reduced cost since only one document need be prepared and mailed.

The various components of the system of the present disclosure are manifest in hardware components known in the art. For instance, the Customer Care Interface can take the form of a CSR with the assistance of a computer terminal. The subscriber can access the CSR via telephone or internet. For instance, the Self-Care Interface can take the form of a subscriber's computer in communication via telephone or the internet with a management server of the CSP. For instance, the Product Catalog can take the form of a computer server accessible to the CSP user via the internet. For instance, the Unified Rating System can take the form of a computer server. The Recurring Charge/Non-recurring Charge Server can take the form of a server. The subscriber has access to the system as a whole via telephone or internet through a computer.

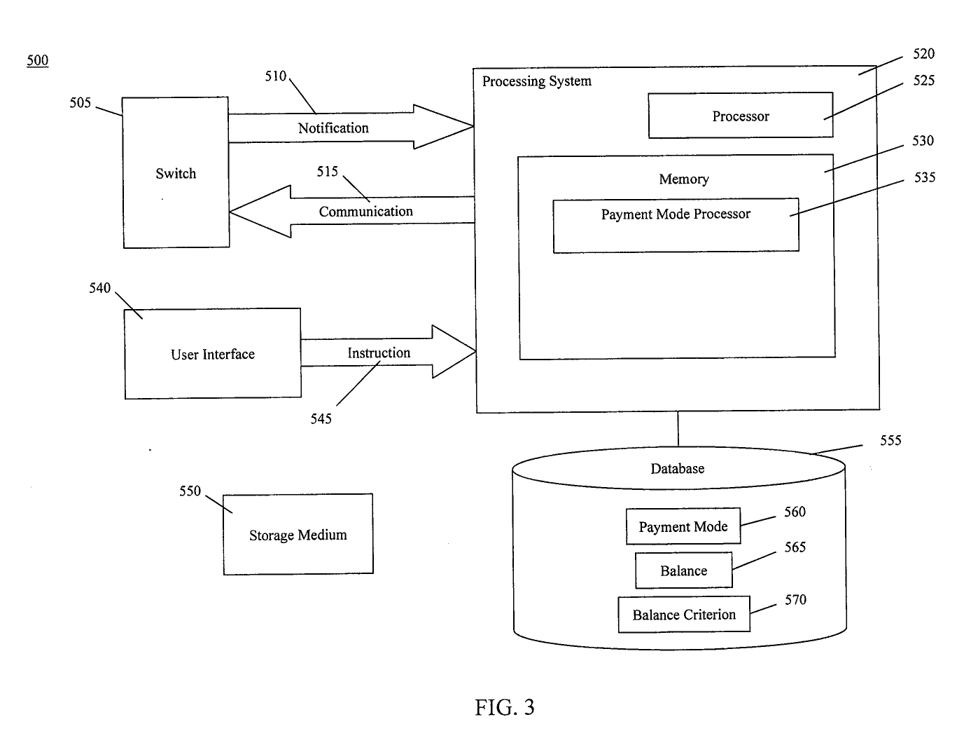

FIG. 3 is a block diagram of a system 500 that facilitates a network communication service for which payment may be made by any of a plurality of payment modes. System 500 includes a switch 505, a processing system 520, a user interface 540, and a database 555.

Switch 505 is a device for facilitating the network communication service, for example a voice call or a data service, over a network (not shown). Switch 505 operates in accordance with a communication 515 in a manner that affects the provision of the service. For example, in response to communication 515, switch 505 may allow the provision of the service, deny the service, or in some other way modify the provision of the service.

Database 555 is a searchable storage system. That is, data stored therein can be located by way of a search query. Database 555 contains data that represents a payment mode 560, a balance 565 and a balance criterion 570. For sake of simplicity, database 555 is shown as having only one each of payment mode 560, balance 565 and balance criterion 570 In practice, database 555 will contain a plurality of these data items. Database 555 may also be configured as a plurality of storage devices, with each of payment mode 560, balance 565 and balance criterion 570 begin in a different one of the plurality of storage devices.

Processing system 520 includes a processor 525 and a memory 530. Processor 525 is configured of logic circuitry that responds to and executes instructions. Memory 530 contains instructions in a payment mode processor module 535 that are readable by processor 525 and control operations of processor 525. The term “module” is used herein to denote a functional operation that may be embodied either as a stand-alone component or as an integrated configuration of a plurality of sub-ordinate components.

Processor 525 receives a notification 510 of an event concerning a network communication service. Processor 525 queries database 555, in response to notification 510, to obtain payment mode 560 for the service. Payment mode 560 is selectable from, that is, it can be any of, a set that includes (a) pre-payment, (b) post-payment, and (c) a hybrid of pre-payment and post payment. Processor 525 determines, in accordance with payment mode 560, whether a balance to fund the service, i.e., balance 565, satisfies balance criterion 570. Processor 525 issues, in accordance with whether balance 565 satisfies balance criterion 570, communication 515, to switch 505, to affect a provision of the service.

The determination of whether balance 565 satisfies balance criterion 570 depends on the status of payment mode 560. If payment mode 560 is “pre-payment”, then processor 525 determines whether a prepaid balance meets a prepaid balance criterion. If payment mode 560 is “post-payment”, then processor 525 determines whether a credit balance meets a credit balance criterion. If payment mode 560 is “hybrid of pre-payment and post payment”, then processor 525 (a) determines whether a prepaid balance meets a prepaid balance criterion and also (b) determines whether a credit balance meets a credit balance criterion.

User interface 540 is a device through which a user can communicate with processing system 520. Through user interface 540, the user can provide an instruction 545 to change payment mode 560 from one mode to another, e.g., from pre-payment to post-payment. Processor 525 receives instruction 545, and updates payment mode 560 in database 555 in accordance with instruction 545. Thereafter, if processor 525 receives a notification 510 concerning a new event, processor 525 will perform the querying, determining and issuing for the new event (based on the updated payment mode 560).

Although processing system 520 is described herein as having payment mode processor module 535 installed into memory 530, payment mode processor module 535 can be tangibly embodied on an external computer-readable storage medium 550 for subsequent loading into memory 535. Storage medium 550 can be any conventional storage medium, including, but not limited to, a floppy disk, a compact disk, a magnetic tape, a read only memory, or an optical storage medium. The instructions could also be embodied in a random access memory (not shown), or other type of electronic storage (not shown), located on a remote storage system and coupled to memory 530.

Processing system 520 is shown herein as being implemented with a single processor 525 and a single memory 530. However, processing system 520 can be implemented as a distributed system configured with a plurality of processors and a plurality of memories. Moreover, although components of processing system 520 are described herein as being installed in memory 530, and therefore being implemented in software, they could be implemented in any of hardware, firmware, software, or a combination thereof.

It should be understood that the foregoing description is only illustrative of the present disclosure. Various alternatives and modifications can be devised by those skilled in the art without departing from the disclosure. Accordingly, the present invention is intended to embrace all such alternatives, modifications and variances which fall within the scope of the appended claims.

What is claimed is:

1. A method comprising:
receiving a notification of an event concerning a network communication service;
querying a database, in response to said notification, to obtain a payment mode for said service, wherein said payment mode is selectable from a set that includes (a) pre-payment and (b) post-payment;
determining, in accordance with said payment mode, whether a balance to fund said service satisfies a balance criterion; and
issuing, in accordance with whether said balance to fund said service satisfies said balance criterion, a communication to a device to affect a provision of said service.

2. The method of claim 1,
wherein if said payment mode is pre-payment, then said determining comprises determining whether a prepaid balance meets a prepaid balance criterion; and
wherein if said payment mode is post-payment, then said determining comprises determining whether a credit balance meets a credit balance criterion.

3. The method of claim 1, wherein said set further includes (c) a hybrid of pre-payment and post payment.

4. The method of claim 3, wherein if said payment mode is said hybrid of pre-payment and post payment, then said determining comprises:
determining whether a prepaid balance meets a prepaid balance criterion; and
determining whether a credit balance meets a credit balance criterion.

5. The method of claim 1,
wherein said event is a first event, and
wherein said method further comprises:
receiving an instruction to change said payment mode;
updating said payment mode in said database, in accordance with said instruction;
receiving a notification of a second event concerning a network communication service; and
performing said querying, determining and issuing for said second event.

6. A system comprising:
a processor; and
a memory that contains instructions that are readable by said processor and cause said processor to perform actions of:
receiving a notification of an event concerning a network communication service;
querying a database, in response to said notification, to obtain a payment mode for said service, wherein said payment mode is selectable from a set that includes (a) pre-payment and (b) post-payment;
determining, in accordance with said payment mode, whether a balance to fund said service satisfies a balance criterion; and
issuing, in accordance with whether said balance to fund said service satisfies said balance criterion, a communication to a device to affect a provision of said service.

7. The system of claim 6,
wherein if said payment mode is pre-payment, then said determining comprises determining whether a prepaid balance meets a prepaid balance criterion; and
wherein if said payment mode is post-payment, then said determining comprises determining whether a credit balance meets a credit balance criterion.

8. The system of claim 6, wherein said set further includes (c) a hybrid of pre-payment and post payment.

9. The system of claim 8, wherein if said payment mode is said hybrid of pre-payment and post payment, then said determining comprises:
determining whether a prepaid balance meets a prepaid balance criterion; and
determining whether a credit balance meets a credit balance criterion.

10. The system of claim 6,
wherein said event is a first event, and
wherein said actions further include:
receiving an instruction to change said payment mode;
updating said payment mode in said database, in accordance with said instruction;
receiving a notification of a second event concerning a network communication service; and
performing said querying, determining and issuing for said second event.

11. A storage medium comprising instructions that are readable by a processor to cause said processor to perform actions of:
receiving a notification of an event concerning a network communication service;
querying a database, in response to said notification, to obtain a payment mode for said service, wherein said payment mode is selectable from a set that includes (a) pre-payment and (b) post-payment;
determining, in accordance with said payment mode, whether a balance to fund said service satisfies a balance criterion; and
issuing, in accordance with whether said balance to fund said service satisfies said balance criterion, a communication to a device to affect a provision of said service.

12. The storage medium of claim 11,
wherein if said payment mode is pre-payment, then said determining comprises determining whether a prepaid balance meets a prepaid balance criterion; and
wherein if said payment mode is post-payment, then said determining comprises determining whether a credit balance meets a credit balance criterion.

13. The storage medium of claim 11, wherein said set further includes (c) a hybrid of pre-payment and post payment.

14. The storage medium of claim 13, wherein if said payment mode is said hybrid of pre-payment and post payment, then said determining comprises:
determining whether a prepaid balance meets a prepaid balance criterion; and
determining whether a credit balance meets a credit balance criterion.

15. The storage medium of claim 11,
wherein said event is a first event, and
wherein said actions further include:
receiving an instruction to change said payment mode; and
updating said payment mode in said database, in accordance with said instruction,
receiving a notification of a second event concerning a network communication service; and
performing said querying, determining and issuing for said second event.
